(19) United States
(12) Patent Application Publication
(10) Pub. No.: US 2021/0056838 A1
(43) Pub. Date: Feb. 25, 2021

(54) TRAFFIC-FLOW CONTROL DEVICE AND DATA STRUCTURE OF TRAVELING SCENARIO

(71) Applicant: HITACHI AUTOMOTIVE SYSTEMS, LTD., Hitachinaka-shi, Ibaraki (JP)

(72) Inventors: Akihiko HYODO, Tokyo (JP); Yasuo SUGURE, Tokyo (JP); Yoshinobu FUKANO, Hitachinaka-shi (JP)

(73) Assignee: HITACHI AUTOMOTIVE SYSTEMS, LTD., Hitachinaka-shi, Ibaraki (JP)

(21) Appl. No.: 16/957,613

(22) PCT Filed: Nov. 21, 2018
(86) PCT No.: PCT/JP2018/043055

§ 371 Date: Jun. 24, 2020

(30) Foreign Application Priority Data
Dec. 27, 2017 (JP) 2017-251850

(51) Int. Cl. G08G 1/01; G08G 1/09; B60W 30/14

(52) U.S. Cl. CPC G08G 1/0112; B60W 30/14; G08G 1/091

(57) ABSTRACT

A traffic-flow control device includes: a benchmark-vehicle operation input section that receives an input of a traveling state of a benchmark vehicle; a scenario input section that reads in a traveling scenario including definitions of target traveling states of a plurality of controlled vehicles using the traveling state of the benchmark vehicle; and a target setting section that computes the target traveling states of the controlled vehicles on the basis of the traveling state and the traveling scenario.

### TECHNICAL FIELD

The present invention relates to a traffic-flow control device and a data structure of a traveling scenario.

### BACKGROUND ART

In recent years, much effort has been devoted to development of automated driving technologies for automobiles. Simulations are often used for examining the performance of developed automated driving devices. In such simulations, various situations that can really occur are created, and the performance of automated driving devices is examined. Specifically, in a simulation, an enormous amount of patterns needs to be prepared by changing, in various manners, not only parameters of a vehicle which is a control target vehicle of an automated driving device, but also parameters of vehicles around the control target vehicle.

Patent Document 1 discloses an automobile simulation driving device. The automobile simulation driving device includes; display means for displaying a simulated visual field image to a driver seated on a simulation driver's seat; user-vehicle-information updating means that, on the basis of a driving operation by the driver, sequentially updates first positional information representing the position, on simulated travel road coordinates, of a virtual user vehicle travelling on a simulated travel road in accordance with the driving operation; moving-body-information updating means that, on the basis of the sequentially updated first positional information, sequentially updates second positional information representing the position, on the simulated travel road coordinates, of a moving body that is present on the simulated travel road or near the simulated travel road, such that a movement of the moving body is synchronized with a movement of the user vehicle; and simulated visual field generating means that, on the basis of the position of the user vehicle represented by the first positional information and the position of the moving body represented by the second positional information, sequentially generates information representing a simulated visual field image that simulates a visual field viewed from the driver's seat of the user vehicle, and causes the simulated visual field image to be displayed on the display means.

### PRIOR ART DOCUMENT

### Patent Document

Patent Document 1: JP-H8-248871-A

### SUMMARY OF THE INVENTION

### Problem to be Solved by the Invention

Realization of a simulation having various variations according to the invention described in Patent Document 1 is very cumbersome.

### Means for Solving the Problem

A traffic-flow control device according to a first aspect of the present invention includes: a benchmark-vehicle operation input section that receives an input of a traveling state of a benchmark vehicle; a scenario input section that reads in a traveling scenario including definitions of target traveling states of a plurality of controlled vehicles, the definitions using the traveling state of the benchmark vehicle; and a target setting section that computes each of the target traveling states of each of the controlled vehicles on the basis of the traveling state and the traveling scenario.

A data structure of a traveling scenario according to a second aspect of the present invention is a data structure of a traveling scenario used for determining an operation of each of a plurality of controlled vehicles, and the data structure includes: a controlled vehicle initial state defining an initial state of one of the controlled vehicles in relation to a benchmark vehicle as a benchmark, the benchmark vehicle being not included in the controlled vehicles; and an operation definition defining an operation performed after the initial state of each of the controlled vehicles.

### Advantages of the Invention

The present invention allows easy realization of a simulation having various variations.

### BRIEF DESCRIPTION OF THE DRAWINGS

FIG. 1 is a hardware configuration diagram of a driving simulation system S.

FIG. 2 is a functional configuration diagram of the driving simulation system S in a first embodiment.

FIG. 3 is a conceptual diagram of a traveling scenario DB 41.

FIG. 4 includes FIG. 4(a) which is a figure illustrating one example of an initial state 43, and FIG. 4(b) which is a schematic diagram illustrating the initial state corresponding to FIG. 4(a).

FIG. 5 includes FIG. 5(a) which is a figure illustrating one example of operation definitions 44, and FIG. 5(b) which is an overview diagram illustrating an operation of a non-user vehicle D1 corresponding to FIG. 5(a).

FIG. 6 is a flowchart representing an operation of a target setting section 31.

FIG. 7 is a flowchart representing an operation of an operation-amount determining section 32.

FIG. 8 is a figure illustrating a target speed of the non-user vehicle D1 in an operation example.

FIG. 9 is a functional configuration diagram of the driving simulation system S in a first modification example.

FIG. 10 includes FIG. 10(a) which is a figure illustrating one example of the initial state 43 in a seventh modification example, and FIG. 10(b) which is a figure illustrating one example of the operation definitions 44 in the seventh modification example.

FIG. 11 is a hardware configuration diagram of a non-user-vehicle control device 30 in a second embodiment.

FIG. 12 is a figure illustrating one example of the operation definitions 44 in the second embodiment.

### MODES FOR CARRYING OUT THE INVENTION

### First Embodiment

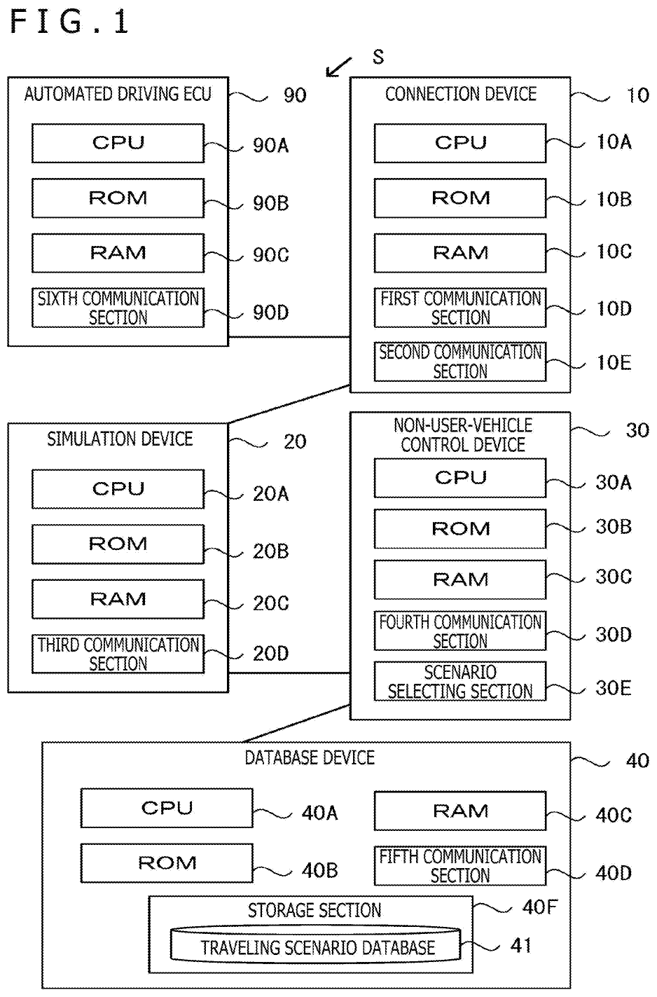

Hereinafter, a first embodiment of a non-user-vehicle control device which is a traffic-flow control device is explained with reference to FIG. 1 to FIG. 8.

(Hardware Configuration)

FIG. 1 is a figure illustrating the hardware configuration of a driving simulation system S. The driving simulation system S includes a connection device 10, a simulation device 20, a non-user-vehicle control device 30, a database device 40 and an automated driving ECU 90. The center of the configuration of the present system is the simulation device 20. The simulation device 20 is connected with the connection device 10 and the non-user-vehicle control device 30 by signal lines, the connection device 10 is connected with the simulation device 20 and the automated driving ECU 90 by signal lines, and the non-user-vehicle control device 30 is connected with the simulation device 20 and the database device 40 by signal lines.

The connection device 10 includes a CPU 10A which is a central processing unit, a ROM 10B which is a read-only storage device, a RAM 10C which is a readable and rewritable storage device, a first communication section 10D and a second communication section 10E. The CPU 10A realizes functions mentioned below, by copying a program stored on the ROM 10B to the RAM 10C, and executing the program. The first communication section 10D is a communication interface that communicates with the automated driving ECU 90, and supports the CAN (Controller Area Network; registered trademark), for example. The second communication section 10E is a communication interface that communicates with the simulation device 20, and supports IEEE802.3, for example. Note that in a case where the automated driving ECU 90 and the simulation device 20 support the same communication method, the connection device 10 only has to include either the first communication section 10D or the second communication section 10E.

The simulation device 20 includes a CPU 20A which is a central processing unit, a ROM 20B which is a read-only storage device, a RAM 20C which is a readable and rewritable storage device and a third communication section 20D. The CPU 20A realizes functions mentioned below, by copying a program stored on the ROM 20B to the RAM 20C, and executing the program. The third communication section 20D is a communication interface that communicates with the connection device 10 and the non-user-vehicle control device 30, and supports IEEE802.3, for example.

The non-user-vehicle control device 30 includes a CPU 30A which is a central processing unit, a ROM 30B which is a read-only storage device, a RAM 30C which is a readable and rewritable storage device, a fourth communication section 30D and a scenario selecting section 30E. The CPU 30A realizes functions mentioned below, by copying a program stored on the ROM 30B to the RAM 30C, and executing the program. The fourth communication section 30D is a communication interface that communicates with the simulation device 20 and the database device 40, and supports IEEE802.3, for example. The scenario selecting section 30E is at least partially constituted by a plurality of buttons, for example, and an operator uses the scenario selecting section 30E to select any of traveling scenarios mentioned below.

The database device 40 includes a CPU 40A which is a central processing unit, a ROM 40B which is a read-only storage device, a RAM 40C which is a readable and rewritable storage device, a fifth communication section 40D and a storage section 40F. The CPU 40A realizes functions mentioned below, by copying a program stored on the ROM 40B to the RAM 40C, and executing the program. The storage section 40F is a non-volatile storage device, and for example is a hard disk drive. A traveling scenario database (hereinafter, traveling scenario DB) 41 is stored on the storage section 40F. The configuration of the traveling scenario DB 41 is mentioned below.

The automated driving ECU 90 is an electronic control unit (Electronic Control Unit) developed and created intended for mounting on a vehicle. It should be noted however that in the present embodiment, the automated driving ECU 90 is not mounted on a vehicle, but is connected to the connection device 10. The automated driving ECU 90 includes a CPU 90A which is a central processing unit, a ROM 90B which is a read-only storage device, a RAM 90C which is a readable and rewritable storage device and a sixth communication section 90D. The CPU 90A realizes functions mentioned below, by copying a program stored on the ROM 90B to the RAM 90C, and executing the program. The sixth communication section 90D is a communication interface that communicates with the connection device 10, and supports the CAN, for example.

(Functional Configuration)

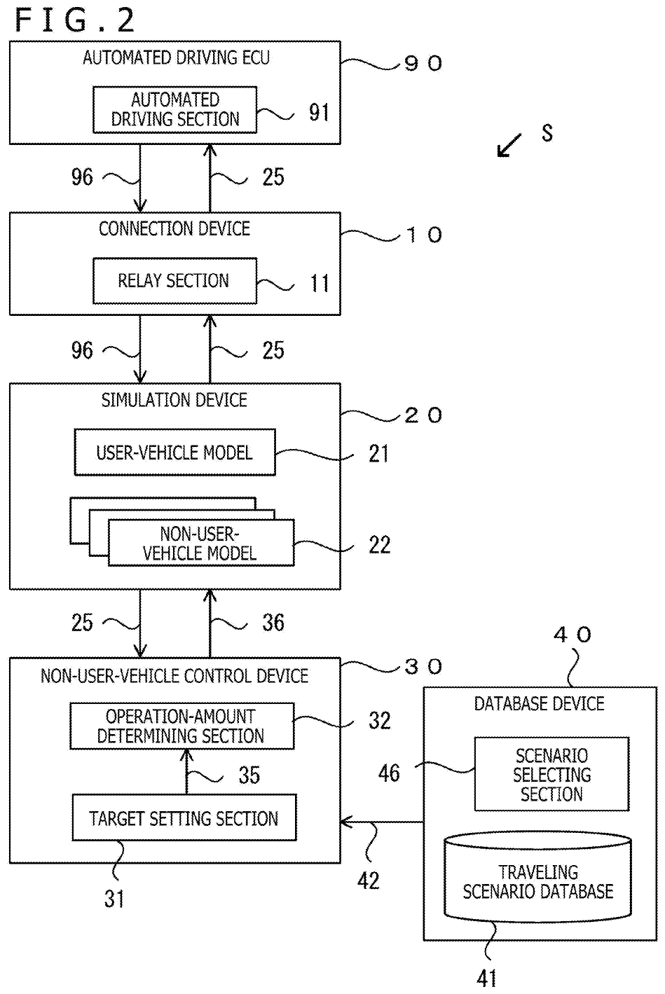

FIG. 2 is a figure illustrating the functional configuration of the driving simulation system S. The driving simulation system S is a system that checks the behavior of the automated driving ECU 90 in various situations through simulation. Hereinbelow, vehicles to be operated by the automated driving ECU 90 are referred to as a “user vehicle” or a “benchmark vehicle.” Then, vehicles other than the user vehicle in the driving simulation system S are referred to as “non-user vehicles” or “controlled vehicles.” In addition, a person who uses the driving simulation system S is referred to as a “user” or an “operator.”

The simulation device 20 includes a user-vehicle model 21 and a plurality of non-user-vehicle models 22. The user-vehicle model 21 and the plurality of non-user-vehicle models 22 are realized by the program mentioned before. The simulation device 20 computes the behaviors of the user vehicle and non-user vehicles per unit time which is 10 ms, for example, in a simulation, and outputs the behaviors as a traveling state 25. The traveling state 25 includes a position, a speed, an acceleration and a posture angle of each vehicle. The posture angle includes a yaw angle, a roll angle and a pitch angle. In the present embodiment, the timings to compute the behaviors of vehicles that occur every time the unit time elapses in a simulation are referred to as “frames.”

Note that the lapse of time in simulations and the lapse of time in the real world do not have to match. For example, the simulation device 20 may perform calculations without taking into consideration the lapse of time in the real world, and output the traveling state 25. In addition, delays in communication between devices, that is, the lapse of time in the real world, may be neglected.

An operation amount of the user-vehicle model 21 is input from the automated driving ECU 90 to the simulation device 20 via the connection device 10, and operation amounts of the non-user-vehicle models 22 are input from the non-user-vehicle control device 30 to the simulation device 20. It should be noted however that hereinbelow the operation amount of the user-vehicle model 21 is also referred to as a user-vehicle operation amount 96, and the operation amounts of the non-user-vehicle models 22 are also referred to as non-user-vehicle operation amounts 36.

On the basis of a state of the user vehicle in a frame and an externally input operation amount, the user-vehicle model 21 computes a position, a speed, an acceleration and an engine speed of the user vehicle in the next frame. The operation amount includes a step-on amount of the accelerator pedal, a step-on amount of the brake pedal, and an operation angle of the steering wheel. On the basis of states of the non-user vehicles in a frame and an externally input operation amount, the non-user-vehicle models 22 compute positions, speeds, accelerations and engine speeds of the non-user vehicles in the next frame. For the user-vehicle model 21 and each non-user-vehicle model 22, the specifications of each vehicle, that is, the mass, the engine characteristics, the brake characteristics and the like of each vehicle are set in advance.

The simulation device 20 receives an input of the user-vehicle operation amount 96 from the automated driving ECU 90 via the connection device 10, and receives an input of the non-user-vehicle operation amounts 36 from the non-user-vehicle control device 30. The simulation device 20 outputs the traveling state 25 to the connection device 10 and the non-user-vehicle control device 30. That is, the simulation device 20 transmits the states of the user vehicle and the non-user vehicles to both the automated driving ECU 90 and the non-user-vehicle control device 30.

The automated driving ECU 90 includes an automated driving section 91 realized by the program mentioned before. The automated driving section 91 operates in accordance with an operation algorithm created in advance, computes an optimum operation amount of the user vehicle in the next frame on the basis of the input traveling state 25 in a frame, and outputs the optimum operation amount as the user-vehicle operation amount 96. The user-vehicle operation amount 96 is transmitted to the simulation device 20 via the connection device 10.

The connection device 10 includes a relay section 11 realized by the program mentioned before. The relay section 11 transmits, to the simulation device 20, the user-vehicle operation amount 96 input from the automated driving ECU 90, and transmits, to the connection device 10, the traveling state 25 input from the simulation device 20.

The non-user-vehicle control device 30 includes a target setting section 31 and an operation-amount determining section 32 that are realized by the program mentioned before. When an operator operates the scenario selecting section 30E to select any of scenarios, the non-user-vehicle control device 30 transfers the selection to the database device 40, and receives the traveling scenario 42 from the database device 40. On the basis of the traveling state 25 received from the simulation device 20, and the traveling scenario 42 received from the database device 40, the target setting section 31 outputs target states 35 of the non-user vehicles. On the basis of the target states 35 of the non-user vehicles output by the target setting section 31, the operation-amount determining section 32 determines individual operation amounts of the non-user vehicles, and outputs the operation amounts to the simulation device 20 as the non-user-vehicle operation amounts 36. Details of operations of the target setting section 31 and the operation-amount determining section 32 are mentioned below.

The non-user-vehicle control device 30 controls many controlled vehicles other than the benchmark vehicle in a simulation. Because of this, it can also be said that the non-user-vehicle control device 30 controls a traffic flow in the simulation by controlling the many controlled vehicles. Accordingly, the non-user-vehicle control device 30 can also be referred to as a “traffic-flow control device.” The fourth communication section 30D receives an input of the traveling state 25. Since the traveling state 25 includes the traveling states of the benchmark vehicle and the controlled vehicles, the fourth communication section 30D can also be referred to as a “benchmark-vehicle operation input section” or a “controlled-vehicle operation input section.” In addition, since the fourth communication section 30D receives an input of the traveling scenario 42, the fourth communication section 30D can also be referred to as a “scenario input section.”

The database device 40 includes a scenario selecting section 46 realized by the program mentioned before. The scenario selecting section 46 reads in, from the traveling scenario DB 41, the traveling scenario 42 requested by the non-user-vehicle control device 30, and transmits the traveling scenario 42 to the non-user-vehicle control device 30.

(Traveling Scenario DB 41)

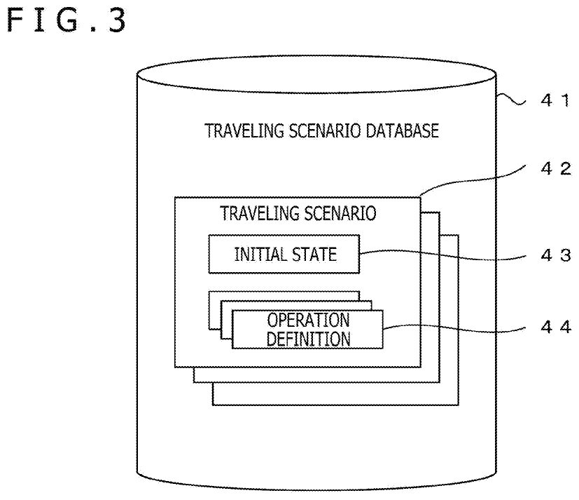

FIG. 3 is a conceptual diagram of the traveling scenario DB 41. The traveling scenario DB 41 stores a plurality of traveling scenario 42. Each traveling scenario 42 is at least partially constituted by an initial state 43, and a plurality of operation definitions 44. As the initial state 43, information on the user vehicle and all the non-user vehicles at the start of a simulation is stored. Each operation definition 44 describes regulations on operations of one non-user vehicle. The initial state 43 and the operation definitions 43 are explained by using specific examples.

(Initial State 43)

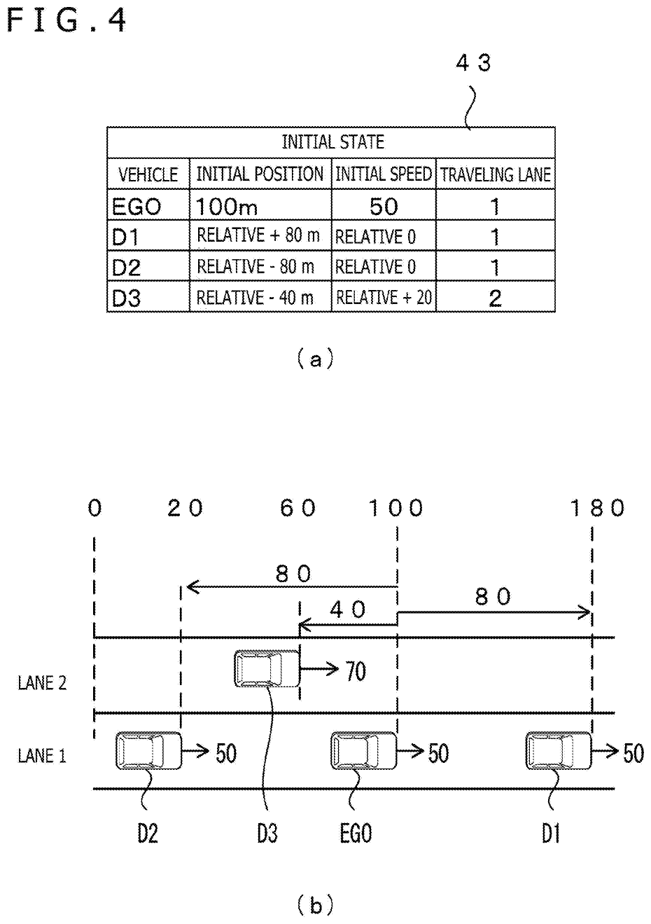

FIG. 4(a) is a figure illustrating one example of the initial state 43. For example, as illustrated in FIG. 4(a), the initial state 43 is represented in a tabular format having a plurality of records, and each record has fields of vehicle, initial position, initial speed, and traveling lane. In each field of vehicle, identification information of a target vehicle of a corresponding record is stored. In the example illustrated in FIG. 4(a), the user vehicle is represented as “EGO,” and non-user vehicles are represented as D1 to D3. In each field of initial position, the position of a corresponding vehicle at the start of a simulation is stored. For example, in the example illustrated in FIG. 4(a), the initial position of the user vehicle EGO is a position 100 meters apart from a benchmark position defined in advance in the simulation. In addition, in the example illustrated in FIG. 4(a), all the initial positions of “D1” to “D3” are represented as relative positions in relation to the position of the user vehicle EGO as a benchmark.

In each field of initial speed, the speed of a corresponding vehicle at the start of a simulation is stored. Although units are not described in the example illustrated in FIG. 4(a), the unit of speeds may be “km/hour” or “miles/minute,” for example. In the example illustrated in FIG. 4(a), the initial speeds of “D1” and “D2” are “RELATIVE 0.” This indicates that the relative speeds in relation to the speed of the user vehicle EGO are zero, that is, the same as the speed of the user vehicle EGO. In each field of traveling lane, an identifier of the traveling lane where a corresponding vehicle is present at the start of a simulation is stored.

Note that in the example illustrated in FIG. 4(a), all the initial positions and the initial speeds of the non-user vehicles are relative positions and relative speeds in relation to the user vehicle EGO as a benchmark. However, positions and speeds of some non-user vehicles may be regulated as absolute positions and absolute speeds like those of the user vehicle EGO.

FIG. 4(b) is a schematic diagram illustrating the initial state corresponding to FIG. 4(a). In FIG. 4(b), the left end of the diagram is the benchmark position, that is, the position at the distance of zero. Then, the user vehicle EGO is at the position of 100 m, and the non-user vehicle D1 is at the relative position of +80 m, and is accordingly at the position of 180 m. The non-user vehicle D2 is at the relative position of −80 m, and is accordingly at the position of 20 m, and the non-user vehicle D3 is at the relative position of −40 m, and is accordingly at the position of 60 m. In addition, the speed of the user vehicle EGO in the initial state is 50, the relative speeds of the non-user vehicle D1 and the non-user vehicle D2 are zero, and accordingly the speeds of the non-user vehicle D1 and the non-user vehicle D2 are the same as the speed of the user vehicle EGO, and are 50. On the other hand, the relative speed of the non-user vehicle D3 is “+20,” and accordingly the speed of the non-user vehicle D3 is 70.

(Operation Definitions 44)

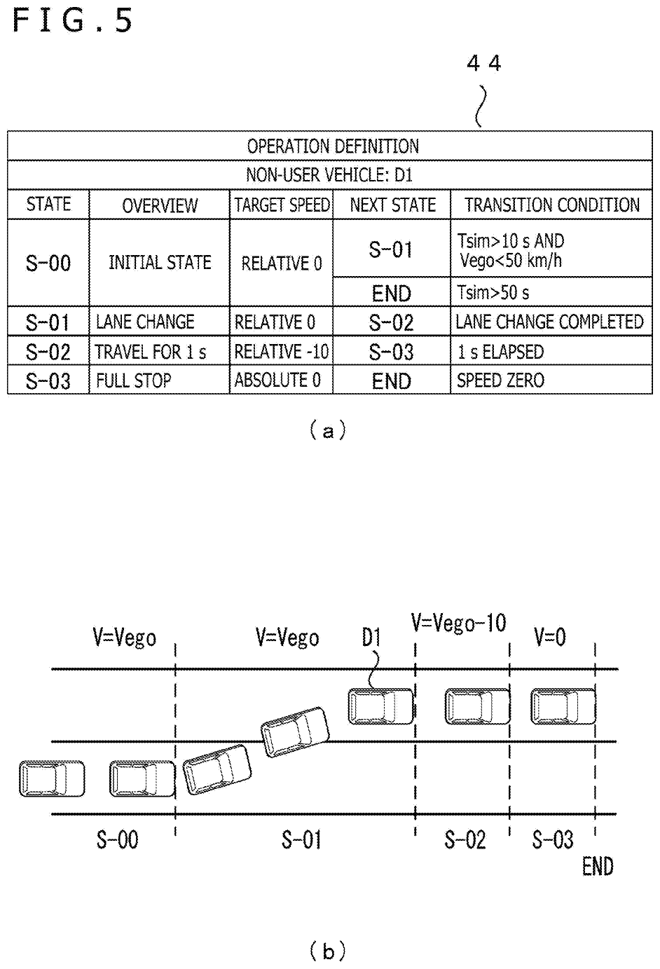

FIG. 5(a) is a figure illustrating one example of the operation definitions 44. For example, as illustrated in FIG. 5(a), the operation definitions 44 are represented in tabular formats each having a plurality of records, and each record has fields of state, overview, target speed, next state and transition condition. In addition, independent of these fields, an identifier of a non-user vehicle which is a target vehicle to which a corresponding operation definition 44 is applied is described at an upper portion of the operation definition 44. In each field of state, an identifier indicating a state is stored. Although in the example illustrated in FIG. 5(a), an identifier of a state is represented by “S” and a two-digit number, the format of identifiers can be any format.

In each field of overview, the overview of an operation in a corresponding state is described. For example, since the first record, which has the state “S-00,” has an overview “INITIAL STATE,” the non-user vehicle to which the operation definition 44 illustrated in FIG. 5(a) is applied starts an operation from S-00. In each field of target speed, a target speed of a non-user vehicle in a corresponding state is stored. The target speed may be a relative speed in relation to the user vehicle EGO as a benchmark or may be an absolute speed.

A decision about a field of next state and a field of transition condition is made by taking into consideration the field of next state and the field of transition condition in combination, and if a condition described in the field of transition condition is satisfied, a transition to the state described in the field of next state occurs. In a case where the condition described in the field of transition condition is not satisfied, a corresponding non-user vehicle remains in the current state. Note that meanings of symbols used in conditional expressions described in fields of transition condition are as follows. That is, Tsim means the elapsed time since the simulation start in a simulation, and Vego means the speed of the user vehicle.

In operation definitions 44, one state has a plurality of sets of next states and transition conditions in some cases, and in such a case, a transition occurs to a next state corresponding to a transition condition that is satisfied first. For example, in the example illustrated in FIG. 5(a), S-00 has two sets of next states and transition conditions, and each has the following meaning. That is, first, in a case where the elapsed time since the simulation start is longer than ten seconds, and the speed of the user vehicle EGO is faster than 50 km/hour, a transition to S-01 occurs. Second, if the elapsed time since the simulation start is longer than 50 seconds, a transition to END occurs, that is, the simulation ends.

State S-01 and the states illustrated below State S-01 in FIG. 5(a) are explained. At State S-01, the non-user vehicle changes the lane while traveling such that its speed becomes a target speed of the relative speed zero, that is, a target speed which is the same as the speed of the user vehicle EGO, and upon completion of the lane change, a transition to S-02 occurs. Lane changes are specified in detail separately, and are performed in the following manner, for example. That is, a virtual path for a lane change is generated in accordance with the speed of the non-user vehicle itself at the time when the non-user vehicle is about to start the lane change, and the non-user vehicle moves to trace the generated path.

At State S-02, the non-user vehicle travels for one second such that its speed becomes a target speed which is 10 km/hour slower than the speed of the user vehicle EGO, and a transition to State S-03 occurs. At State S-03, the non-user vehicle travels such that its speed becomes a target speed which is zero, and when the speed of the non-user vehicle becomes zero, a transition to State END occurs, that is, the simulation ends.

FIG. 5(b) is an overview diagram illustrating an operation of the non-user vehicle D1 corresponding to FIG. 5(a). FIG. 3(b) illustrates the state of the non-user vehicle D1 when transitions occur, from the left end of the FIG. 3(b), from State S-00 through State S-01, State S-02 and State S-03 to State END. It is assumed that the target speed of the non-user vehicle D1 illustrated in FIG. 5(b) is the same as the speed of the user vehicle EGO in State S-00. Since the speed of the user vehicle EGO is faster than 50 km/hour, and the state continued longer than 10 seconds, a transition to State S-01 occurs, and the non-user vehicle D1 changes the lane. Upon completion of the lane change, a transition of the non-user vehicle D1 to State S-02 occurs, the non-user vehicle travels for one second such that its speed becomes a target speed which is 10 km/hour slower than the speed of the user vehicle, and thereafter a transition to State S-03 occurs. At State S-03, the non-user vehicle D1 travels such that its speed becomes a target speed which is zero, and when the speed of the non-user vehicle becomes zero, the simulation ends.

(Target Setting Section 31)

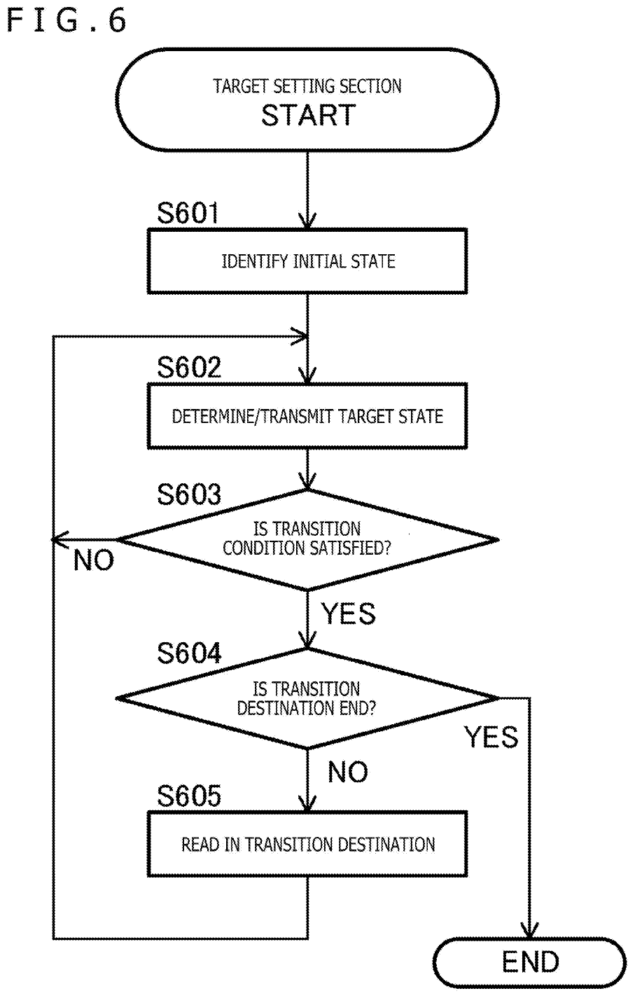

FIG. 6 is a flowchart representing an operation of the target setting section 31. The section that executes each step of the flowchart explained below is the CPU 30A of the non-user-vehicle control device 30. It should be noted however that the flowchart illustrated in FIG. 6 is described about only one non-user vehicle. The target setting section 31 actually performs similar processes for a plurality of non-user vehicles.

At S601, which is the first step, the target setting section 31 identifies and reads in a record representing an initial state from a traveling scenario 42 received from the database device 40. At the subsequent S602, the target setting section 31 determines a target state 35 on the basis of the description of the record that has been read in, and transmits the target state 35 to the operation-amount determining section 32. For example, in the case of State S-00, which is the initial state in the example illustrated in FIG. 5, the target state 35 is determined as “zero speed difference from benchmark vehicle.” At the subsequent S603, the target setting section 31 decides whether or not a transition condition in the record that has been read in is satisfied. In a case where the target setting section 31 decides that the transition condition is satisfied, the target setting section 31 proceeds to S604, and in a case where the target setting section 31 decides that the transition condition is not satisfied, the target setting section 31 returns to S602. Note that in a case where the record that has been read in includes a plurality of transition conditions, and where the target setting section 31 decides that any of the transition conditions is satisfied, the result of the decision at S602 is YES.

At S604, the target setting section 31 decides whether or not the transition destination corresponding to the transition condition decided as being satisfied at S603 is END. In a case where the target setting section 31 decides that the transition destination is END, the target setting section 31 ends the process of the present flowchart, and in a case where the target setting section 31 decides that the transition destination is not END, the target setting section 31 proceeds to S605. At S605, the target setting section 31 reads in a record of the transition destination, and returns to S602.

(Operation-Amount Determining Section 32)

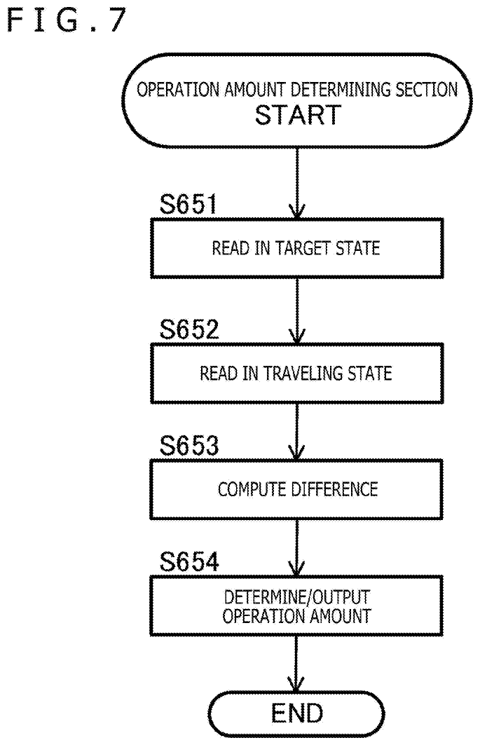

FIG. 7 is a flowchart representing an operation of the operation-amount determining section 32. The section that executes each step of the flowchart explained below is the CPU 30A of the non-user-vehicle control device 30. It should be noted however that the flowchart illustrated in FIG. 7 is described about only one non-user vehicle. The operation-amount determining section 32 actually performs similar processes for a plurality of non-user vehicles. The non-user vehicle which is treated as a target vehicle whose operation amount is determined in FIG. 7 is referred to as here a “control-target non-user vehicle.” Every time the operation-amount determining section 32 receives an input of a target state 35 from the target setting section 31, the operation-amount determining section 32 performs the operation illustrated in FIG. 7.

At S651, which is the first step, the operation-amount determining section 32 reads in a target state 35 received from the target setting section 31. At the subsequent S652, the operation-amount determining section 32 reads in a traveling state 25 received from the simulation device 20. It should be noted however that at this time, the operation-amount determining section 32 does not have to read in the entire traveling state 25, but may read in only information related to the target state 35 that has been read in at S651. For example, in a case where the target state 35 is “zero speed difference from benchmark vehicle,” the operation-amount determining section 32 may read in only a speed of the benchmark vehicle and a speed of the control-target non-user vehicle. At the subsequent S653, the operation-amount determining section 32 computes the difference between the target state 35 and the current state, that is, the traveling state 25. For example, in a case where the target state 35 is “zero speed difference from benchmark vehicle,” the difference between the speed of the benchmark vehicle and the speed of the control-target non-user vehicle in the immediately preceding frame is computed.

At the subsequent S654, the operation-amount determining section 32 determines an operation amount on the basis of the difference computed at S653, and outputs the determined operation amount as the non-user-vehicle operation amount 36 to the simulation device 20. For example, the relationship between the difference and the operation amount may be represented in a lookup table created in advance or may be represented by a relational expression of the difference and the operation amount defined in advance. After the process explained above, the operation of the operation-amount determining section 32 ends.

(Operation Example)

As an operation example of the non-user-vehicle control device 30, it is explained how the state transition and the target speed of the non-user vehicle D1 change depending on the speed of the benchmark vehicle in a case where the non-user-vehicle control device 30 reads in the initial state 43 illustrated in FIG. 4(a) and the operation definition 44 illustrated in FIG. 5(a). Since the operation amount of the benchmark vehicle is input from the automated driving ECU 90, the speed of the benchmark vehicle can be changed without changing the traveling scenario 42.

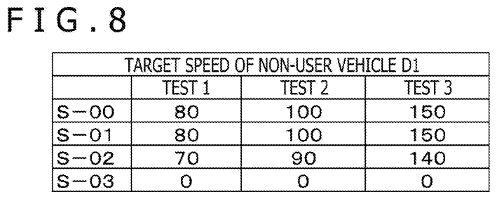

FIG. 8 is a figure illustrating a target speed of the non-user vehicle D1 in the operation example. It should be noted however that the description of the unit of the target speed of the non-user vehicle D1 is omitted in FIG. 8. In this operation example, three simulations, Test 1 to Test 3, are performed by using the initial state 43 illustrated in FIG. 4(a) and the operation definition 44 illustrated in FIG. 5(a). The automated driving ECU 90 outputs the operation amount such that the speed of the benchmark vehicle becomes 80 km/hour in Test 1, 100 km/hour in Test 2, and 150 km/hour in Test 3. In this case, the target speed of the non-user vehicle D1 changes in accordance with the speed of the benchmark vehicle as illustrated in FIG. 8. In this manner, by using the non-user-vehicle control device 30, it is possible to perform a plurality of simulations without changing the traveling scenario 42.

According to the first embodiment mentioned above, the following action and effect are attained.

(1) The non-user-vehicle control device 30, which can be referred to as a traffic-flow control device, includes: the fourth communication section 30D (benchmark-vehicle operation input section) that receives an input of the traveling state 25 of the benchmark vehicle and non-user vehicles; the fourth communication section 30D (scenario input section) that reads in the traveling scenario 42 including definitions of target traveling states of a plurality of controlled vehicles, the definitions using a traveling state of the benchmark vehicle; and the target setting section 31 that computes each of target states 35 of each of the controlled vehicles on the basis of the traveling state 25 and the traveling scenario 42. Because of this, simulations of different situations become possible only by changing the traveling state, such as the speed, of the benchmark vehicle, without rewriting the traveling scenario 42. If the speed of the user vehicle is changed in ten different ways, a simulation of ten different situations becomes possible. That is, by using the non-user-vehicle control device 30, realization of a simulation having various variations becomes easy.

(2) The non-user-vehicle control device 30 includes the operation-amount determining section 32 that determines an operation amount of the controlled vehicle on the basis of the target state 35 computed by the target setting section 31. Since the non-user-vehicle control device 30 determines the operation amount of the controlled vehicle, it is not necessary for the simulation device 20, which is operated in combination with the non-user-vehicle control device 30, to compute the operation amount.

(3) The operation amount includes an operation amount of an accelerator, a brake and a steering wheel. By determining the operation amounts that directly affect operations of the vehicles, it becomes possible to make operations of the controlled vehicles resemble real operations.

(4) The traveling scenario 42 includes the initial state 43 of each of the plurality of controlled vehicles and the operation definitions 44 for the controlled vehicles, and each of the operation definitions 44 includes a plurality of states each of which regulates an operation of the controlled vehicle, and transition conditions each of which is a condition under which a transition to the state occurs. The target setting section 31 manages a transition of each of the controlled vehicles from the initial state to the state. Because of this, the target setting section 31 can set a target state defined for each state of each non-user vehicle. That is, different situations can be taken into consideration for different non-user vehicles in a complicated manner, and various target states can be set.

(5) The data structure of the traveling scenario 42 used for determining an operation of each of the plurality of controlled vehicles includes: the controlled vehicle initial state defining an initial state of the controlled vehicle, the initial state being defined in relation to the benchmark vehicle as a benchmark, the benchmark vehicle being not included in the controlled vehicles; and the operation definition defining an operation performed after the initial states of each of the controlled vehicles. Because of this, by making different the operation of the benchmark vehicle after the initial state, a simulation having various variations can be realized without rewriting the traveling scenario 42.

(6) The operation definitions 44 include a plurality of states each of which regulates an operation of the controlled vehicle, and transition conditions each of which is a condition under which a transition to the state occurs. A target control state of a controlled vehicle is set for each state. One of the target control states is set for at least one of the states and indicates a relative relationship with the operation of the benchmark vehicle. Because of this, by defining an operation of a controlled vehicle for each state, complicated operations of the controlled vehicle can be realized. Furthermore, since operations of controlled vehicles are described in terms of relative relationships with the benchmark vehicle, a simulation having various variations can be realized without rewriting the traveling scenario 42.

### First Modification Example

In the first embodiment, the operation-amount determining section 32 is provided to the non-user-vehicle control device 30. However, the operation-amount determining section 32 may be provided to the simulation device 20. In this case, the non-user-vehicle control device 30 transmits the target state 35 to the simulation device 20.

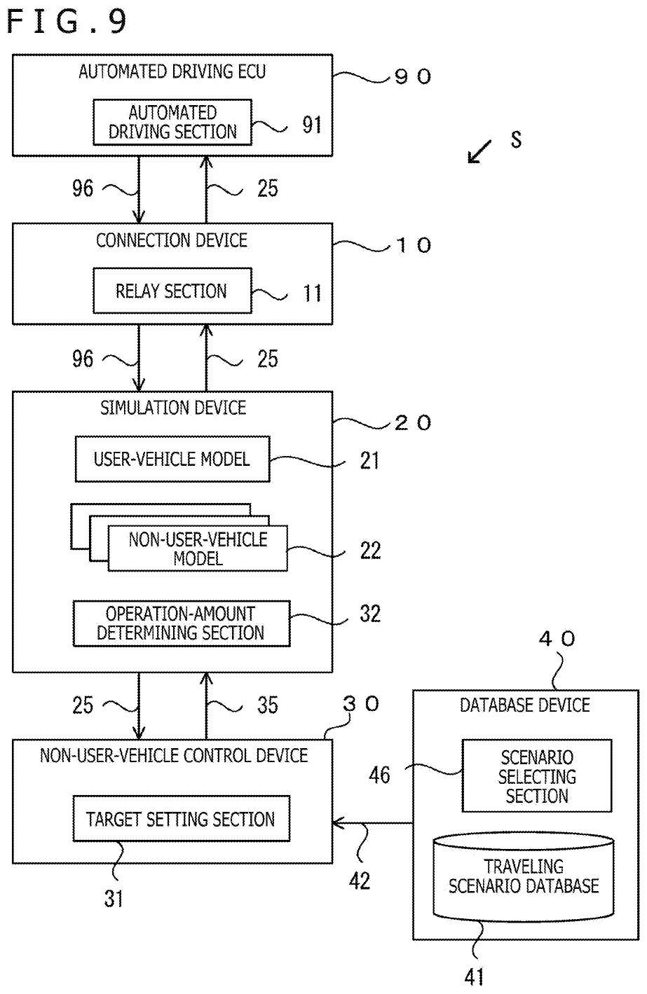

FIG. 9 is a diagram illustrating the functional configuration of the driving simulation system S in a first modification example. As mentioned before, the operation-amount determining section 32 is provided to the simulation device 20 in the present modification example. According to this first modification example, the computation amount by the non-user-vehicle control device 30 can be reduced since the non-user-vehicle control device 30 does not include the operation-amount determining section 32.

### Second Modification Example

Instead of transmitting the traveling state 25 input from the simulation device 20 directly to the automated driving ECU 90, the relay section 11 may simulate outputs of sensors provided to a vehicle on which the automated driving ECU 90 is to be mounted. For example, on the basis of the traveling state 25 input from the simulation device 20, the relay section 11 may generate outputs simulating a laser range finder and a camera, and output the generated outputs to the automated driving ECU 90.

### Third Modification Example

The specifications of the benchmark vehicle and controlled vehicles do not have to be preset in the simulation device 20. In that case, the traveling scenario 42 includes the specifications of each vehicle, and the simulation device 20 receives the traveling scenario 42 from the database device 40. Then, the simulation device 20 uses the specifications of each vehicle included in the traveling scenario 42 to operate the user-vehicle model 21 and the non-user-vehicle models 22.

### Fourth Modification Example

Two or more those including the connection device 10, the simulation device 20, the non-user-vehicle control device 30 and the database device 40 may be configured as an integrated device. In addition, the scenario selecting section 30E may be provided to a device other than the non-user-vehicle control device 30. Note that the user-vehicle model 21 and the non-user-vehicle models 22 may be executed at different devices, and the plurality of non-user-vehicle models 22 may individually be executed at different devices. In addition, the target setting section 31 and the operation-amount determining section 32 may be executed at different devices.

### Fifth Modification Example

Although the connection device 10 and the automated driving ECU 90 need to be installed at the same location, the connection device 10, the simulation device 20, the non-user-vehicle control device 30 and the database device 40 may be installed at physically separated places. That is, these devices may individually be installed at different places, and connected through long distance communication, for example, the Internet. For example, Company A developing the automated driving ECU 90 may lease the connection device 10 from Company B providing simulation services, install the connection device 10 at Company A along with the automated driving ECU 90, and communicate with the simulation device 20 installed at Company B through the Internet. Furthermore, there may be Company C providing the traveling scenario 41 to Company B, and the database device 40 installed at Company C may be connected to the non-user-vehicle control device 30 installed at Company B through the Internet.

### Sixth Modification Example

The initial state 43 constituting at least part of the traveling scenario 42 includes initial states of the user vehicle and the non-user vehicles. However, the initial state 43 only has to include the initial states of the non-user vehicles, but may not include the initial state of the user vehicle. In this case, the initial state of the user vehicle is provided to the simulation device 20 separately.

### Seventh Modification Example

In the first embodiment mentioned above, the initial state 43 and the operation definitions 44 in the traveling scenario 42 include relative descriptions in relation to an operation state of the benchmark vehicle as a benchmark. However, the benchmark for the relative descriptions is not limited to the benchmark vehicle. That is, the descriptions may be descriptions of an initial state and a target state of a non-user vehicle in relation to another non-user vehicle as a benchmark.

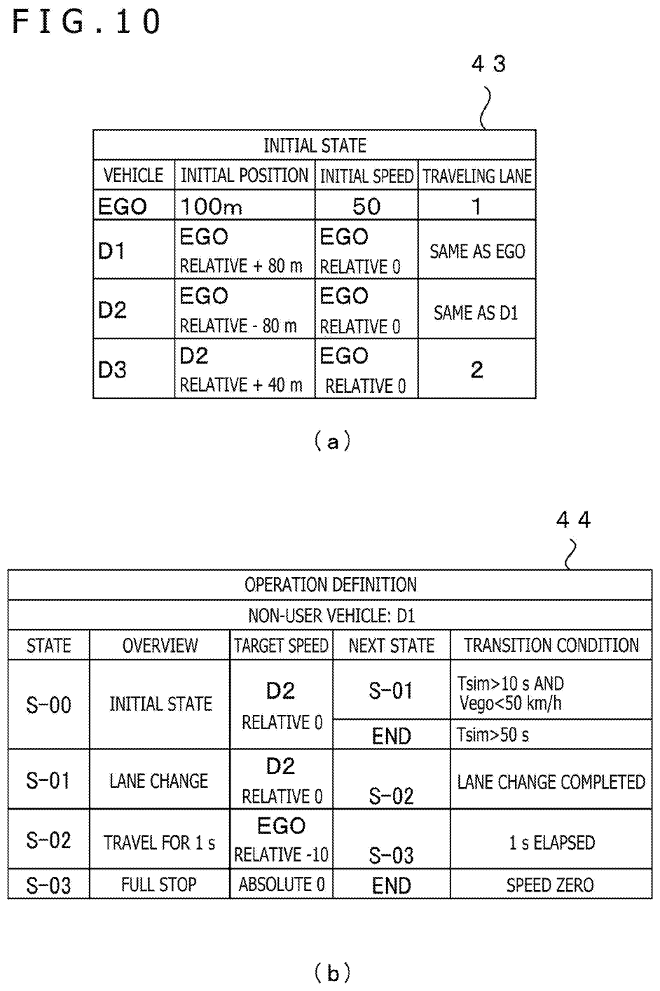

FIG. 10(a) is a figure illustrating one example of the initial state 43 in a seventh modification example, and FIG. 10(b) is a figure illustrating one example of the operation definitions 44 in the seventh modification example. Since there can be a plurality of benchmarks used in relative relationships of initial states and target states in the example illustrated in FIG. 10, it is clearly described which are treated as benchmarks. For example, the initial position of the non-user vehicle D1 in the initial state 43 is “EGO RELATIVE+80 m,” which means +80 m in relation to the benchmark vehicle EGO as a benchmark. In addition, the initial position of the non-user vehicle D3 is “D2 RELATIVE+40 m,” which means+40 m in relation to the non-user vehicle D2 as a benchmark.

According to this seventh modification example, the following action and effect are attained.

(7) The traveling scenario 42 includes a definition of a target traveling state of a controlled vehicle, the definition using a traveling state of another controlled vehicle. The non-user-vehicle control device 30 includes the fourth communication section 30D (controlled-vehicle operation input section) that receives an input of a traveling state of a controlled vehicle. The target setting section 31 computes a target traveling state of a controlled vehicle by using a traveling state of another controlled vehicle. Because of this, the non-user-vehicle control device 30 can set the target state of the controlled vehicle by using the traveling scenario 42 describing a relative relationship between the controlled vehicles.

(8) The operation definition 44 of the traveling scenario 42 includes a plurality of states each of which regulates an operation of the controlled vehicle, and transition conditions each of which is a condition under which a transition to the state occurs. In the operation definitions 44, a target control state of a controlled vehicle is set for each state. One of the target control states is set for at least one of the states in the operation definitions 44 and indicates a relative relationship with the operation of other one of the controlled vehicles. Because of this, in a case where a traveling scenario 42 is edited to create another traveling scenario 42, and where relative relationships between controlled vehicles remain unchanged, those descriptions need not be changed, and editing can be performed simply and easily.

### Eighth Modification Example

The database device 40 does not have to include the CPU 40A, the ROM 40B and the RAM 40C, but only has to include an interface for communication with the storage section 40F and the non-user-vehicle control device 30. In this case, the non-user-vehicle control device 30 searches the traveling scenario DB 41, and reads in a traveling scenario 42 selected by an operator through the scenario selecting section 30E.

### Ninth Modification Example

The connection device 10 may include a display section, and display the traveling state 25 input from the simulation device 20. In addition, the non-user-vehicle control device 30 may cause operation definitions 44 and current states of individual non-user vehicles to be displayed on the display section provided to the connection device 10.

### Tenth Modification Example

The target setting section 31 may compute specific target amounts, and output the target amounts to the operation-amount determining section 32. For example, in the first embodiment, the target state 35 is set to that “speed difference from benchmark vehicle speed is zero” as one example. However, in a case where the target setting section 31 refers to the speed of the benchmark vehicle included in the traveling state 25 and specifically, for example, the speed of the benchmark vehicle is 55 km/hour, the target state 35 may be set to “target speed: 55 km/hour.”

### Eleventh Modification Example

In the first embodiment mentioned above, the operation definitions 44 include target states of non-user vehicles which are regulated in terms of relative relationships with the speed of the benchmark vehicle. However, the physical quantity of the benchmark vehicle used for regulating target states of non-user vehicles is not limited to the speed of the benchmark vehicle. For example, an acceleration, a yaw rate or a position may be used. For example, if a target state of a non-user vehicle is regulated in terms of a relative relationship with the yaw rate of the benchmark vehicle, when the benchmark vehicle changes the lane, the non-user vehicle also changes the lane similarly.

### Second Embodiment

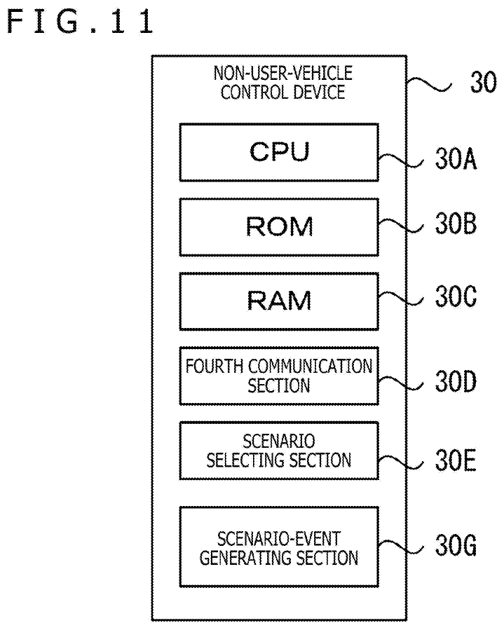

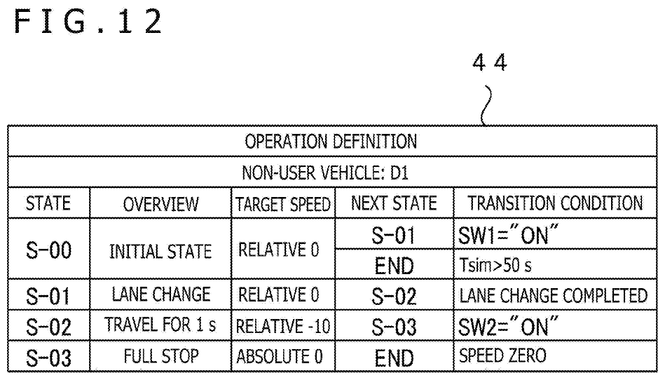

A second embodiment of the non-user-vehicle control device which is a traffic-flow control device is explained with reference to FIG. 11 to FIG. 12. In the following explanation, constituent elements which have counterparts in the first embodiment are given the same reference characters, and differences are mainly explained. Points that are not explained particularly are the same as counterparts of the points in the first embodiment. In the present embodiment, a main difference from the first embodiment is that the non-user-vehicle control device 30 includes an input section that affects a scenario. In addition, the operation definitions 44 of the traveling scenario 42 are also different from those in the first embodiment.

FIG. 11 is a hardware configuration diagram of the non-user-vehicle control device 30 in the second embodiment. The non-user-vehicle control device 30 in the second embodiment further includes a scenario-event generating section 30G in addition to the configuration in the first embodiment. The scenario-event generating section 30G includes one or more buttons, for example. The scenario-event generating section 30G is operated by an operator, and if any of the buttons is pressed, an indication that the button is pressed is transferred to the CPU 30A. In the present embodiment, the scenario-event generating section 30G includes two switches, SW1 and SW2. In addition, default states of those switches are OFF states, and they are switched to ON states by operations of the switches by an operator.

FIG. 12 is a figure illustrating one example of the operation definitions 44 in the second embodiment. In the operation definition 44 illustrated in FIG. 12, descriptions in the uppermost field and the second lowermost field of transition condition are different from those in the operation definition 44 illustrated in FIG. 5(a) in the first embodiment. That is, ‘SW1=“ON”’ is described in the uppermost field and ‘SW2=“ON”’ is described in the second lowermost field. Because of this, in a case where the non-user vehicle D1 is in State S-00, and SW1 is turned on by an operator, the target setting section 31 causes a transition to State S-01 to be occurred. In addition, in a case where the non-user vehicle D1 is in State S-02, and SW2 is turned on by an operator, the target setting section 31 causes a transition to State S-03 to be occurred.

According to the second embodiment mentioned above, the following action and effect are attained.

(9) The traveling scenario 42 is used for an operation simulation of each of a plurality of vehicles, the operation simulation being executed at a device connected with the scenario-event generating section 30G that can receive an input by a user, that is, an operator, at any timing. Transition conditions included in the operation definition 44 of the traveling scenario 42 include input to the scenario-event generating section 30G. Because of this, by making different operation timings of the scenario-event generating section 30G by an operator, realization of a simulation having various variations is easy without rewriting the traveling scenario 42.

Each of the embodiments and the modification examples mentioned above may be combined with each other. Although various embodiments and modification examples are explained in the description above, the present invention is not limited to the content of those embodiments and modification examples. Other aspects that are conceivable within the scope of the technical idea of the present invention are also included in the scope of the present invention.

The content disclosed by the following priority application document is incorporated herein as citations:
Japanese Patent No. 2017-251850 (filed on Dec. 27, 2017)

### DESCRIPTION OF REFERENCE CHARACTERS

10: Connection device
11: Relay section
20: Simulation device
21: User-vehicle model
22: Non-user-vehicle model
25: Traveling state
30: Non-user-vehicle control device
30G: Scenario-event generating section
31: Target setting section
32: Operation-amount determining section
35: Target state
36: Non-user-vehicle operation amount
40: Database device
40F: Storage section
41: Traveling scenario database
42: Traveling scenario
43: Initial state
44: Operation definition
46: Scenario selecting section
91: Automated driving section
96: User-vehicle operation amount

1. A traffic-flow control device comprising:
a benchmark-vehicle operation input section that receives an input of a traveling state of a benchmark vehicle;
a scenario input section that reads in a traveling scenario including definitions of target traveling states of a plurality of controlled vehicles, the definitions using the traveling state of the benchmark vehicle; and
a target setting section that computes each of the target traveling states of each of the controlled vehicles on a basis of the traveling state and the traveling scenario.

2. The traffic-flow control device according to claim 1, further comprising:
an operation-amount determining section that determines an operation amount of the controlled vehicle on a basis of the target traveling state computed by the target setting section.

3. The traffic-flow control device according to claim 2, wherein
the operation amount includes an operation amount of an accelerator, a brake and a steering wheel.

4. The traffic-flow control device according to claim 1, wherein
the traveling scenario includes an initial state of each of the plurality of controlled vehicles and operation definitions for the controlled vehicles, and each of the operation definitions includes a plurality of states each of which regulates an operation of the controlled vehicle, and transition conditions each of which is a condition under which a transition to the state occurs, and
the target setting section manages a transition of each of the controlled vehicles from the initial state to the state.

5. The traffic-flow control device according to claim 1, further comprising:
a controlled-vehicle operation input section that receives an input of a traveling state of the controlled vehicle,
the traveling scenario including definitions of target traveling states of a second controlled vehicle, the definitions using a traveling state of a first controlled vehicle,
the target setting section computing a target traveling state of the second controlled vehicle by using the traveling state of the first controlled vehicle.

6. A data structure of a traveling scenario used for determining an operation of each of a plurality of controlled vehicles, the data structure comprising:
a controlled vehicle initial state defining an initial state of at least one of the controlled vehicles, the initial state being defined in relation to a benchmark vehicle as a benchmark, the benchmark vehicle being not included in the controlled vehicles; and
an operation definition defining an operation performed after the initial state of each of the controlled vehicles.

7. The data structure of the traveling scenario according to claim 6, wherein
the operation definition includes a plurality of states each of which regulates an operation of the controlled vehicle, and transition conditions each of which is a condition under which a transition to the state occurs,
a target control state of the controlled vehicle is set for each of the states, and
one of the target control states is set for at least one of the states and indicates a relative relationship with an operation of the benchmark vehicle.

8. The data structure of the traveling scenario according to claim 7, wherein
the relative relationship includes at least one of a relative speed, a relative acceleration, a relative yaw rate and a relative position.

9. The data structure of the traveling scenario according to claim 6, wherein
the operation definition includes a plurality of states each of which regulates an operation of the controlled vehicle, and transition conditions each of which is a condition under which a transition to the state occurs,
a target control state of the controlled vehicle is set for each of the states, and
one of the target control states is set for at least one of the states and indicates a relative relationship with an operation of other one of the controlled vehicles.

10. The data structure of the traveling scenario according to claim 9, wherein
the relative relationship includes at least one of a relative speed, a relative acceleration, a relative yaw rate and a relative position.

11. The data structure of the traveling scenario according to claim 6, wherein
the operation definition includes a plurality of states each of which regulates an operation of the controlled vehicle, and transition conditions each of which is a condition under which a transition to the state occurs,
the traveling scenario is used for an operation simulation of each of a plurality of vehicles, the operation simulation being executed at a device connected with a scenario-event generating section that can receive an input by a user at any timing, and
the transition conditions include the input into the scenario-event generating section.
